(19) United States
(12) Patent Application Publication
(10) Pub. No.: US 2015/0120391 A1
(43) Pub. Date: Apr. 30, 2015

(54) ENHANCED WEIGHING AND ATTRIBUTES FOR MARKETING REPORTS

(71) Applicant: CELLCO PARTNERSHIP (D/B/A VERIZON WIRELESS), Arlington, VA (US)

(72) Inventors: Christopher M. Jodice, Secaucus, NJ (US); Dustin L. Applegate, Shaker Heights, OH (US); Vadim Pliner, Fair Lawn, NJ (US)

(73) Assignee: CELLCO PARTNERSHIP (D/B/A VERIZON WIRELESS), Arlington, VA (US)

(21) Appl. No.: 14/063,865

(22) Filed: Oct. 25, 2013

(51) Int. Cl. G06Q 30/02

(52) U.S. Cl. CPC G06Q 30/0204
USPC 705/7.33

(57) ABSTRACT

A computing device may generate target area breakdowns of demographic information for a plurality of geographic areas based on identified key demographic variables of subscribers of a subscriber network, determine subscriber demographic breakdowns for each of the target area breakdowns based at least in part on subscriber base information descriptive of subscribers of the subscriber network, and perform rim weighting of the subscriber demographic breakdowns to generate rim weights for each subscriber according to the respective target area breakdowns. The device may further generate index scores according to weighted subscriber information indicative of relative likelihood of a subscriber being associated with an attribute as compared to the population of the associated geographic area, identify business rules including criteria for association of a subscriber with an advanced attribute, the criteria including a minimum index score for an attribute; and assign the advanced attribute to the subscriber based on subscriber index score.

### BACKGROUND

A reports generator may be faced with a challenge of making the subscriber base of a population of users representative of the population at large in both size and demographic proportions. However, demographic unknowns of portions of the subscriber base make such processing difficult. Moreover, due to the many different possible demographic variables, it may be difficult to make the population representative of many disparate variables at the same time. Moreover, while demographic or other aspects of subscribers may be easy to identify for reporting, more complicated subscriber behaviors or histories may be difficult to identify in proper proportions in reporting products.

### BRIEF DESCRIPTION OF THE DRAWINGS

FIG. 1 illustrates an exemplary system for providing subscriber reports based on collected data from subscriber network devices.

FIG. 2 illustrates an exemplary breakdown of demographic variables for a population associated with an area identifier.

FIG. 3 illustrates an exemplary set of demographic variables for a population associated with an area identifier as compared to a subscriber population.

FIG. 4 illustrates an exemplary graphical representation of rim weighting.

FIG. 5 illustrates an exemplary comparison of determined rim weights to a set of demographic variables for a population associated with an area identifier

FIG. 6 illustrates an exemplary capping of national weights for a population of subscribers.

FIG. 7 illustrates an exemplary listing of business rules to be used in the association of advanced attributes with subscribers.

FIG. 8 illustrates an exemplary process for the generation of rim weights and national weights to use in report generation.

FIG. 9 illustrates an exemplary process for performing rim weighting, extrapolation, and weight capping.

FIG. 10 illustrates an exemplary process for the assignment of advanced attributes to subscribers.

FIG. 11 illustrates an exemplary process for the generation of reports from aggregate subscriber data.

### DETAILED DESCRIPTION

A reporting system is dependent on the quality of the data on which it reports. For example, a reporting system providing demographic data regarding subscribers of the system may provide skewed reports if the subscriber population deviates from the general population at large. As an example, a system may incorrectly report a large percentage of married persons frequent a restaurant, simply because the subscriber population is overwhelmingly married. To address these issues, the system may perform a weighting and extrapolation process to reduce bias in a subscriber base. The system may assign weights to subscribers that are commensurate with the subscriber's demographics and geographic home location to each subscriber, to reflect the amount of contribution that each subscriber should have to data regarding the area in which the subscriber is based.

The system may apply higher weights to subscribers who are demographically under-represented, given their demographics, and lower weights to those who are demographically over-represented. An exemplary set of demographic variables for which the subscriber base may be weighted may include: age, gender, income, education, marital status, presence of children in the household, primary language, race, and whether the subscriber is a homeowner. The system may also perform extrapolation on the subscriber base to weigh the subscriber base to be representative in size of the population at large.

The system may utilize a technique referred to as rim weighting (or sequential weighting) to generate the subscriber weights. Rim weighting operates by assigning an initial design weight to each subscriber, and proportionally adjusting and correcting the subscriber weights for one demographic variable at a time, towards a target for that variable in a set of variables. Since rim weighting is a sequentially-adjusted process, the system may utilize a static predefined ordering of the demographic variables to ensure consistency in calculation of the weights. For instance, using the aforementioned set of demographic variables, the rim weighting may operate by producing, in a first step of an iteration, rim weights correcting for a first of the nine variables (e.g., age). In a next step of the iteration, the rim weighting may generate, based on the age rim weights, a revised set of the rim weights, but this time correcting for the second of the nine demographic attributes (e.g., gender). This iterative process may continue until the rim weights converge within a predefined convergence limit, or until it becomes clear that the rim weights are unable to converge. Due to the intense processing power required in order to generate the rim weights, it should be noted that the rim weighting cannot be effectively performed without the use of a computing device including a processor and a memory.

To ensure the validity of the resultant weights, the system may be configured to audit the resultant weights to ensure that they remain consistent with the population at large. It should be noted that if there are no subscribers having a particular demographic characteristic, then that demographic characteristics can never converge (e.g., if there are no males, then no amount of weighting of an all females population will ever be representative of male behavior).

In some cases, based on limitations of the subscriber base, certain individual subscribers may be assigned exceedingly high weights, such that certain under-represented subscribers have a substantial effect on weighted reporting outputs. Accordingly, the system may apply capping and flooring techniques to the generated subscriber weights to reduce the effect of such outlier subscribers, while still maintaining acceptable adjustment of the subscriber population to the general population.

The weighted subscriber data may be used to facilitate accurate generation and reporting of relative aspects of the population at large. For example, the system may be configured to perform index computation of subscriber characteristics relative to the proportions found in the weighted aggregate subscriber data, to allow for profiling of subscribers in terms of likely shopping habits, phone behavior, activities, interests, and travel, in current as well as historical timeframes. As an illustration, rather than associating a subscriber with an attribute based on proximity to a retailer a predetermined number of times within a time period (e.g., five visits to a discount retailer), the advanced attributes may associate the subscriber with the attribute based on relative proximity to the retailer as compared to the exposure of the population at large (e.g., 1.5 times more likely to visit a discount retailer than average). Advanced attributes may accordingly identify aspects of the behavior of the subscribers that may be useful for making marketing decisions. Moreover, based on the advanced attributes, the system may be further configured to send notifications over the subscriber network including suggested courses of action determined according to the advanced attributes (e.g., to adjust staffing or inventor levels at various business locations).

Thus, by weighting subscriber information according to demographic and behavioral information regarding the subscribers (e.g., from marketing information vendors such as Experian™ or Acxiom™), a system may determine aggregate intelligence about subscriber behavior and characteristics over the subscriber network balanced according to the population at large. The aggregated data about the subscribers, including advanced attributes determined using the weighted information, may accordingly be used to provide reports allowing marketers and other viewers to gain insight into their current or prospective customers. Note that to the extent the various embodiments herein collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

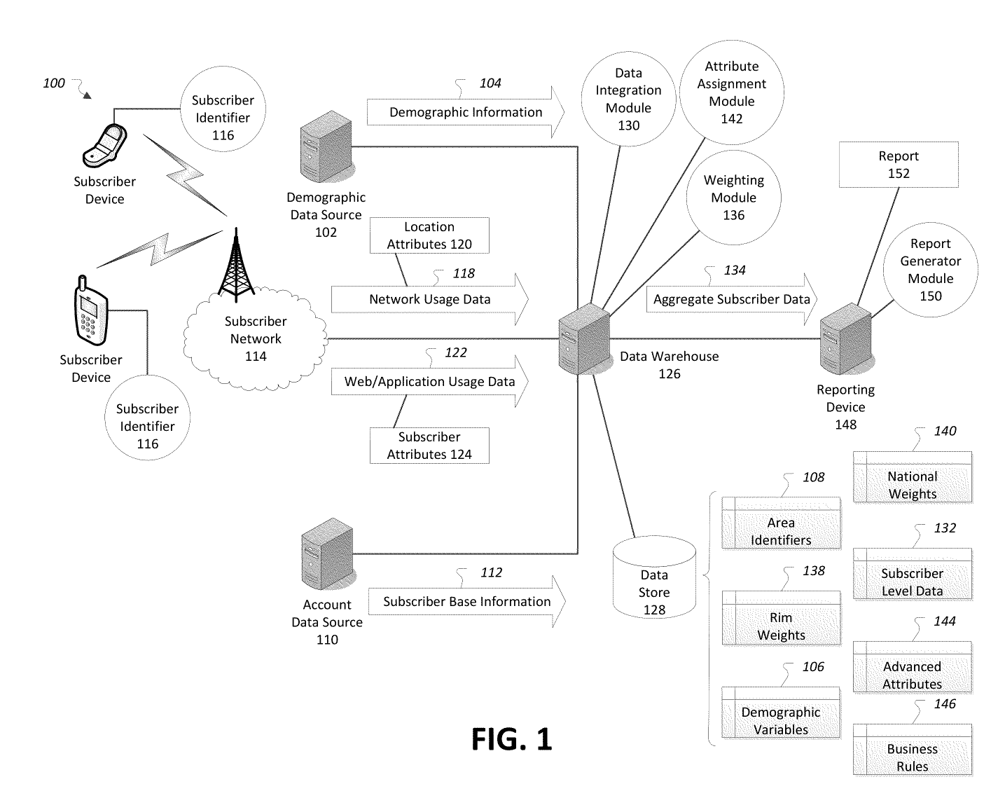

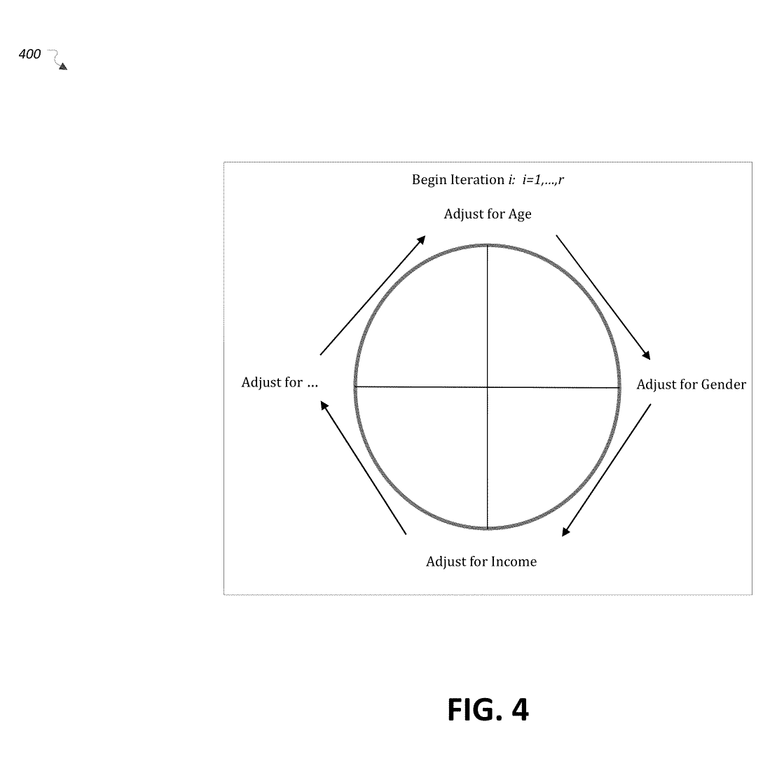

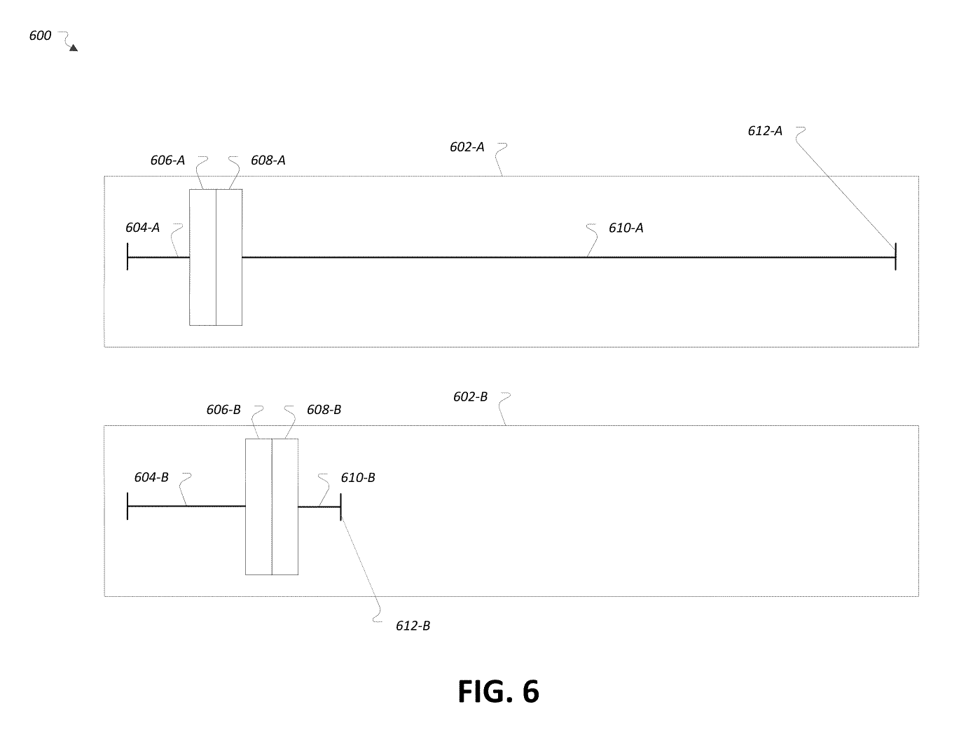

FIG. 1 illustrates an exemplary system 100 for providing subscriber reports 152 based on weighted and extrapolated data collected from subscriber network 114 devices. The system may include a demographic data source 102 configured to provide demographic information 104 including demographic variables 106 and area identifiers 108, and an account data source 110 configured to provide subscriber base information 112. The system 100 may further include a subscriber network 114 configured to provide communications services to a plurality of subscriber devices, and to generate network usage data 118 including location attributes 120 and web and application usage data 122 including subscriber attributes 124 based on the provided services. The data warehouse 126 may be configured to receive demographic information 104 from demographic data sources 102, and to use a data aggregation module 130 to process the received data into aggregate subscriber data 134 matched by subscriber identifiers 116. The data warehouse 126 may be further configured to generate rim weights 138 (discussed in more detail below such as with respect to FIG. 4) and national weights 140 (also discussed in more detail below such as with respect to FIGS. 4 and 6 as well as equation 10) using a weighing module 136, and to use an attribute assignment module 142 to perform assignment of advanced attributes 144 to the subscribers according to system-defined business rules 146. The data warehouse 126 may include a data store 128 configured to store demographic variables 106, area identifiers 108, subscriber-level data 132, rim weights 138, national weights 140, advanced attributes 144 and business rules 146. The system 100 may also include a reporting device 148 including a report generator module 150 configured to receive requests for reports 152 according to advanced attribute 144, and to generate the reports 152 based on the aggregate subscriber data 134. The system 100 may take many different forms and include multiple and/or alternate components and facilities. While an exemplary system 100 is shown in FIG. 1, the exemplary components illustrated in Figure are not intended to be limiting. Indeed, additional or alternative components and/or implementations may be used.

The demographic data sources 102 may be configured to provide demographic information 104 regarding the demographic characteristics of a population at large. Exemplary demographic data sources 102 may include census information, as well as third-party compiled information from vendors such as Experian™ or Acxiom™. The demographic information 104 may include a total number and breakdown of the included population according to various demographic variables 106, such as the percentages of the population in each category. Exemplary demographic variables 106 may include, as some examples: age (e.g., 18-24, 25-34, 35-44, 45-54, 55-64, 65-74, 75+), gender (male, female), income ($0-$14,999, $15,000-$24,999, $25,000-$34,999, $35,000-$49,999, $50,000-$74,999, $75,000-$99,999, $100,000-$104,999, $125,000+), education (high school or less, college, graduate school), marital status (married, single), presence of children in the household (yes, no), primary language (English, Spanish, etc.), race (white, Asian, black, Hispanic, other, etc.), and whether the subscriber is a homeowner (own, rent).

In addition to demographic variables 106, the demographic information 104 may further be broken down geographically. As some examples, the demographic data source 102 may provide demographic information about a population broken down according to one or more of state, zip code, and Nielson designated market areas (DMAs). The demographic information 104 may be indexed according to area identifiers 108 indicative of the relevant subarea. For each area identifier 108, the demographic information 104 may include the breakdown of the included population according to various demographic variables 106. Exemplary area identifiers 108 may include identifiers of the different states of the United States, identifiers of zip codes, and DMA identifiers, as some examples. In some cases, the demographic information 104 may be provided at multiple geographic levels (e.g., DMA, state, national), while in other cases, data at higher geographic levels may be left to be computed by a user of the demographic information 104.

The account data sources 110 may be configured to provide billing or other subscriber base information 112 regarding customer accounts. The subscriber base information 112 may include addresses, ages, genders, or other accountholder information relevant to the system 100, such as tariff plans to which the subscribers are subscribed, and subscriber identifiers 116 of subscriber devices authorized to use the subscriber network 114 under the subscriber's account.

The subscriber network 114 may provide communications services, such as packet-switched network services (e.g., Internet access, VoIP (Voice over Internet Protocol) communication services) and location services (e.g., device positioning), to devices connected to the subscriber network 114. Exemplary subscriber networks 114 may include a VoIP network, a VoLTE (Voice over LTE) network, a cellular telephone network, a fiber optic network, and a cable television network, as some non-limiting examples.

Subscriber devices on the subscriber network 114 may be associated with subscriber identifiers 116 used to unique identify the corresponding devices. Subscriber identifiers 116 may include various types of information sufficient to identify the identity of a subscriber or a subscriber device over the subscriber network 114, such as mobile device numbers (MDNs), mobile identification numbers (MINs), telephone numbers, common language location identifier (CLLI) codes, Internet protocol (IP) addresses, and universal resource identifiers (URIs), as some non-limiting examples.

The subscriber network 114 may generate data records representing usage the subscriber network 114 by the subscriber devices for various purposes such as billing and network traffic management. Exemplary network usage of the subscriber network 114 may include placing or receiving a telephone call, sending or receiving a text message, using a web browser to access Internet web pages, and interacting with a networked application in communication with a remote data store. A usage data record of a subscriber making use of the subscriber network 114 may be referred to herein as a transaction or transaction record. Usage records of transactions may include information indexed according to the subscriber identifier 116 of the device using the subscriber network 114. For example, data records of phone calls and SMS messages sent or received by a subscriber device may include the MDN of the originating device and of the destination devices.

The subscriber network 114 may be configured to capture network usage data 118 from various network elements. Network usage data 118 may include data captured when a subscriber is involved in a voice call over the subscriber network 114, sends or receives a text message over the subscriber network 114, or otherwise makes use of a data or voice service of the network to communicate with other subscriber devices accessible via the subscriber network 114. The network elements of the subscriber network 114 may include a collection of network switches or other devices throughout the subscriber network 114 configured to track and record these subscriber transactions, e.g., regarding usage of the subscriber network 114 services by subscriber communications devices for billing purposes. This data collected by the network switches or other devices may include, for example, bandwidth usage, usage duration, usage begin time, usage end time, line usage directionality, endpoint name and location, and quality of service, as some examples. The network usage data 118 may use the collected data to identify and include information regarding when the communications took place, as well as identifiers of the network switches or other devices throughout the subscriber network 114 from which location information may be determined. It should be noted that approximate times may be sufficient for inclusion in the network usage data 118 (e.g., rounded to the nearest second or five seconds), rather than the full precision of time information that may be captured by the subscriber network 114. Accordingly, the network usage data 118 may include records of subscriber actions typically recorded by the subscriber network 114 in the ordinary course of business.

The subscriber network 114 may further include a location identification module configured to receive network usage data 118 from the various network switches of the subscriber network 114, and determine the location fixes for collected items of network usage data 118, such as for calls or text messages. To do so, the location identification module may locate the network device and associate the device with one or more locations (e.g., venues, points of interest, roadway segments). For instance, the location fixes may be associated with points of interest by matching the determined location fixes to point of interest data including geographic locations of point of interest (e.g., latitude and longitude, GPS coordinates, etc.), names of the points of interest (e.g., Starbucks® coffeehouses, Wal-Mart®, etc.), and categories of point of interest (e.g., Coffeehouses, Discount Retailers, etc.).

One exemplary method for determining location information to include in network usage data 118 may be to use advanced forward link trilateration (AFLT), whereby a time difference of arrival technique is employed based on responses to signals received from multiple nearby base stations. The distances from the base stations may be estimated from round trip delay in the responses, thereby narrowing down the location information without requiring subscriber devices to be capable of global positioning systems (GPS) or other types of location identification. If available, GPS may additionally or alternately be used to provide location fixes for network usage data 118. Another method for determining location information to include in network usage data 118 is by way of identification of a communication being served by an antenna system (e.g., by access points each associated with unique access point identifiers) configured to operate in a confined and specific area, such as a section of a stadium or other venue. For example, identifying a subscriber device according to an access point identifier of the access point from which the subscriber device is being served may allow for determination of location data regarding the subscriber position within the venue with relatively high accuracy and precision.

The location fixes may include data such as: a latitude/longitude pair, a timestamp, a precision value (e.g., radius in meters), and an identifier of the associated subscriber device. The precision value of the location fixes may vary according to the precision of the mechanism used to determine the location of the subscriber device. For example, a GPS-derived location may include a precision value of approximately 5-30 meters, an AFLT-derived location may include a precision value of approximately 30-200 meters, and a time difference of arrival-derived location may include a precision value of approximately 100-200 meters, as some examples.

The location identification module may identify and associate the location fixes with the captured network usage data 118 to indicate locations of the subscriber devices when the records of network usage data 118 were captured. For example, the location identification module may be configured to associate the received network usage data 118 with corresponding location attributes 120 of area identifiers 108, geo-fence information related to the location of the underlying call or subscriber network 114 use, or associations of the transaction record with a point of interest, such as a store or other landmark at or nearby the indicated location.

The location identification module may model probabilities of subscribers being at various points of interest. For example, the location identification module may model subscriber distance from a center of a location fix as following a Gaussian (or Lorentzian or other) distribution, such that the higher the distance, the lower the probability. Notably, since the probability of subscriber location depends on distance, the determination is rotationally invariant. A standard deviation may be set such that a cumulative probability of the subscriber being inside a circle with radius equal to the precision of the location fix and center equal to the center of the location fix may have a relatively large probability (e.g., 90%).

To determine what points of interest are associated with the location fix, the location identification module may determine a cumulative probability of the subscriber being inside an area of each of a plurality of points of interest. In one exemplary approach, each of the point of interests or other location may be modeled as a radius R that is a distance D from a center coordinate of the point of interest. As the probability of the subscriber being at a specific distance from the center of the location fix decreases with distance, the lower the distance of the point of interest to the center of the location fix, the higher the probability of the subscriber being within the point of interest. Similarly, the larger the radius R, the higher the probability of the subscriber being at the point of interest for the same precision of location fix. Additionally, the higher the precision of the location fix, the smaller the probable area of the location fix and the lower the probability of the subscriber being at the point of interest for the same point of interest radius R. A cumulative probability that a subscriber at a given location fix is within an area of a point of interest may thus be found by integrating a probability distribution as follows (where the precision of the fix may be used to determine the σ):

$$C D F ( R , D ) = \frac{1}{2 {πσ}^{2}} {\int }_{0}^{2 π} {\int }_{0}^{R} r {e}^{\frac{- ( {D}^{2} + {r}^{2} - 2 Dr sin θ )}{2 {σ}^{2}}} d r d θ \qquad ( 1 )$$

The location identification module may be configured to perform a symmetrical numerical approximation to evaluate the cumulative distribution function Formula (1), as evaluation of the Formula (1) directly may be computationally expensive. The symmetrical numerical approximation may evaluate the cumulative distribution function at the location fix by splitting the probability area of the location fix into radial slices (e.g., defined by two circles with radius Rᵢ and Rᵢ₊₁, with Rᵢ₊₁>Rᵢ, where the cumulative distribution function of the slice is equal to CDF(Rᵢ₊₁)−CDF(Rᵢ). Using the slices, the location identification module may approximate that the value of the probability distribution function is the same inside each slide, and therefore that the cumulative probability of the subscriber being located at any slice part is linearly proportional to the area of that part. The greater the number of slices, the more accurate the approximation. Given an arbitrary point of interest R and D, the cumulative probability that corresponds to the overlapping area between the point of interest and a slice is therefore equal to:

(CDF(Rᵢ₊₁)−CDF(Rᵢ))*overlapping area/slice areaᵢ (2)

Accordingly, the location identification module may use the cumulative distribution function and the location fixes to determine distances of subscribers from points of interest (e.g., stores and venues), as well as probabilities of the subscriber being at the points of interest. It should be noted that there may be some ambiguity in the determined locations, such that for a single location fix, a subscriber may potentially be indicated as being at multiple different point of interest location attributes 120, each with an associated probability (e.g., a 30% change of being at a Starbucks, and a 25% chance of being at a Best Buy for a single location fix).

The subscriber network 114 may also be configured to capture web and application usage data 122 from various network elements. These network elements may include a collection of regional distribution centers or other devices throughout the subscriber network 114 containing equipment used to complete wireless mobile data requests to data services, such as websites or data repositories feeding data to device applications. The distribution centers may be configured to track subscriber transactions and record web and application usage data 122 regarding Internet usage of subscriber network 114 services by subscriber communications devices, e.g., as part of tracking subscriber usage to facilitate billing. In some cases, the distribution centers may be configured to perform more detailed data gathering than required for billing purposes, such as deep packet inspection to obtain details of hypertext transfer protocol (HTTP) header information or other information being requested or provided to the subscriber devices of the subscriber network 114. Thus, the distribution centers may be configured to capture web and application usage data 122 related to mobile internet usage by network service provider subscribers including data such as: end time of receiving information from a uniform resource locator (URL) address, duration of time spent at the URL, a (hashed or otherwise encrypted) identifier of the subscriber MDN, an indication of the HTTP method used (e.g., GET, POST), the URL being accessed, user agent strings (e.g., including device operating system, browser type and browser version), an indication of content type (e.g., text/html), a response code resulting from the HTTP method, a number bytes sent or received, an indication of a type of sub-network over which the usage was made (e.g., 3G, 4G), indications of usage of mobile applications, lengths of time spend performing browsing and application use, number of application downloads, and network topology location where the URL was accessed or the application was used or downloaded.

The subscriber network 114 may further include analytics functionality configured to assign categories to the URLs and applications used (e.g., “news”, “sports”, “real estate”, “social”, “travel”, “business”, “automotive”, etc.). For example, a visit to the CNN website may be assigned to a “news” category, while a visit to the ESPN website may be assigned to a “sports” category. The analytics functionality may be further configured to assign subscriber attributes 124 to the web and application usage data 122 records based on the category analysis. A subscriber attribute 124 may be indicative of a preference of the subscriber for content in a particular category of content. A subscriber may be associated with zero or more subscriber attributes 124. For example, the analytics functionality may analyze the processed web and application usage data 122 for a subscriber (e.g., keyed to a subscriber identifier 116) over a period of time (e.g., per day) to derive subscriber attributes 124 for that subscriber's records over the time period.

For instance, a subscriber who has browsed several websites within the “sports” category during the day might be associated with a “sports enthusiast” subscriber attribute 124. As another example, a subscriber who frequents travel websites may be associated with a “business travel” subscriber attribute 124. As yet a further example, a subscriber who frequents discount websites may be associated with a “discount shopper” subscriber attribute 124. The analytics functionality may utilize various heuristics to determine how much subscriber activity may be required to associate a subscriber with a category. For example, the analytics functionality may utilize a minimum threshold number of visits to websites in a category to associate the subscriber with that category (e.g., three visits in a day), or a minimum threshold percent of visits to websites in the category (e.g., 15% of a subscriber's requests) to associate the subscriber with that category. In some cases, the analytics functionality may require subscriber activity for a category in a plurality of periods of time (e.g., over multiple days, such as three of the last twenty-eight days) in order to associate a subscriber with a category. In addition, these thresholds may vary according to the categories being associated with the subscribers. For instance, a travel enthusiast may have a lower threshold than sports enthusiast (e.g., two visits in a day to travel sites as compared to five visits in a day to sports website) because an expected amount of usage over the same time period to be associated with the category may vary from category to category. Moreover, the analytics functionality may update subscriber attributes 124 associated with the subscribers based on data received for later periods of time.

The data warehouse 126 may be configured to receive and maintain network usage data 118 and web and application usage data 122 from the subscriber network 114 as well as demographic information 104 from the demographic data sources 102. Before transmission to the data warehouse 126, the subscriber network 114 may be configured to utilize a hashing module to convert subscriber identifiers 116 included in the network usage data 118 and web and application usage data 122 (e.g., customer mobile numbers, origination MIN, dialed digits) into hashed identifiers using a pre-defined two-way encryption methodology. The data warehouse 126 may be configured to decrypt the data using the methodology, to allow for secure transmission of the network subscriber data from the subscriber network 114 to the data warehouse 126. In some cases the data warehouse 126 may receive periodic updates from the subscriber network 114, such as daily aggregated updates of network usage data 118 and web and application usage data 122.

The data warehouse 126 may also include a data integration module 130 configured to associate network usage data 118 and web and application usage data 122 with the subscribers defined in the subscriber base information 112. For example, the data integration module 130 may be configured to correlate the network usage data 118 and web and application usage data 122 together based on individual subscriber identifiers 116 (e.g., MDNs of the subscriber devices, subscriber names, etc.), thereby providing combined information related to location attributes 120 as well as related to subscriber attributes 124. This combined subscriber information may be referred to as subscriber-level data 132, and may be maintained by the data store 128 of the data warehouse 126.

The data warehouse 126 may also include a weighting module 136 configured to identify the demographic breakdown of subscribers in the subscriber-level data 132 according to area identifiers 108. For example, the weighting module 136 may identify the areas in which the subscribers are associated according to billing address information included in the subscriber base information 112, and may determine the demographic breakdown of the subscribers according to area.

Based on differences between the demographic makeup of the subscribers and the population at large, the weighting module 136 may determine rim weights 138 to apply to the subscriber-level data 132 to weigh and extrapolate the subscriber-level data 132 to be representative of the population at large. A rim weight 138 may be a scaling factor applied to a data of a subscriber commensurate with the subscriber's demographics and geographic home location to each subscriber, to reflect the amount of contribution that each subscriber should have to data regarding the area in which the subscriber is based. The weighting module 136 may apply higher weights to subscribers who are demographically under-represented, given their demographics, and lower weights to those who are demographically over-represented. For example, a larger weight may cause actions by the weighted subscriber to be counted more heavily in data analysis than subscribers associated with lower weights (e.g., because an instance of their actions is multiplied by the corresponding subscriber rim weight 138). By applying the rim weights 138 to the subscriber-level data 132 to adjust the data to be in conformance with the population at large, the weighting module 136 may increase the accuracy and predictive value of the subscriber-level data 132. The weighting module 136 may also determine national weights 140, which may be created based on the rim weights 138 for areas covering multiple or even all the area identifiers 108. It should be noted that while the national weights 140 are discussed in certain examples in the context of national geographic areas, the national weights 140 are not limited to national geographic areas, and may more generally relate to cumulative geographical areas or global geographic areas that are not necessarily “national.”

The weighting module 136 may be further configured to extrapolate the rim weights 138 and national weights 140 to adjust the size of the subscriber base data to match the demographic size of the areas to which the subscribers are assigned. The weighting module 136 may be further configured to apply a cap to the rim weights 138 to prevent significantly underrepresented subscribers from having too great of an influence over the data.

To maintain accuracy of the system 100, the weighting module 136 may be further configured to perform validations on the rim weights 138 and national weights 140 before applying the weights to the data store 128 to be maintained and used to weight and extrapolate subscriber data. If the weighting module 136 determines that the rim weights 138 and national weights 140 are valid, the weighting module 136 may store the updated weights in the data store 128. If not, the weighting module 136 may set an error flag if the rim weights 138 and national weights 140 fail to conform (e.g., stored by the data warehouse 126), and may continue to use previously computed rim weights 138 and national weights 140 or use the data without weighs.

Once weighted and extrapolated, the data warehouse 126 may be further configured to ensure subscriber anonymity by aggregating the subscriber-level data 132, for example, by removing subscriber identifiers 116 from the subscriber-level data 132. The data warehouse 126 may be configured to aggregate the subscriber-level data 132 into aggregate subscriber data 134 according to a set of subscriber profiles. A subscriber profile may be defined as a combination of attributes values, such as by combinations of the subscriber attributes 124 and location attributes 120. To generate the aggregate subscriber data 134, the data warehouse 126 may match the subscriber-level data 132 to the subscriber profiles, and may use the rim weights 138 or national weights 140 associated with the subscribers to weigh the subscriber transactions being aggregated to determine total extrapolated counts for individuals matching the subscriber profiles.

The data warehouse may further include an attribute assignment module 142 configured to perform index computation of subscriber characteristics relative to the proportions found in the weighted aggregate subscriber data 134, and also advanced attribute 144 assignment based on the calculated indexes. In some examples, index scores are specified as values in a range from approximately 10 to 350. For example, a value of 100 would indicate that the subscriber is of average likelihood for the associated attribute or for visiting an associated point of interest location or category of point of interest location, while a value of 150 would indicate that the subscriber is 1.5 times as likely as average of having the association.

The attribute assignment module 142 may be further configured to use business rules 146 to determine advanced attributes 144 to be associated with the subscribers of the subscriber-level data 132. Advanced attributes 144 may be based on aspects of the subscribers represented in the subscriber-level data 132, and may provide high level information regarding the categorization or behavior of the associated subscriber in comparison to the population at large. For example, an advanced attribute 144 may indicate that an associated subscriber has an affinity toward high-end shopping or has a higher than average likelihood of making a particular purchase. Business rules 146 may include criteria and other logic used to describe the characteristics of a subscriber for whom the various advanced attributes 144 of the system are to be assigned. Accordingly, the advanced attributes 144 may be associated with the subscribers to allow for profiling of subscribers in terms of likely shopping habits, phone behavior, activities, interests, and travel, in current as well as historical timeframes.

The reporting device 148 may be configured to utilize a report generator module 150 to receive the aggregate subscriber data 134 and a request for a report 152. The request may include criteria for which matching subscribers should be received. The report generator module 150 may be further configured to query the aggregate subscriber data 134 for matching subscriber information, and to provide the report 152 responsive to the request based on the resultant subscriber information. As one example, a report 152 may be requested for subscribers that attended a particular event at a venue who were associated with a particular advanced attribute 144. An advertiser may receive the report 152, and may use the information, for example, to determine whether to place an ad on an ad unit targeting those types of persons or to analyze the reach of an advertisement placed on the ad unit in targeting those types of persons.

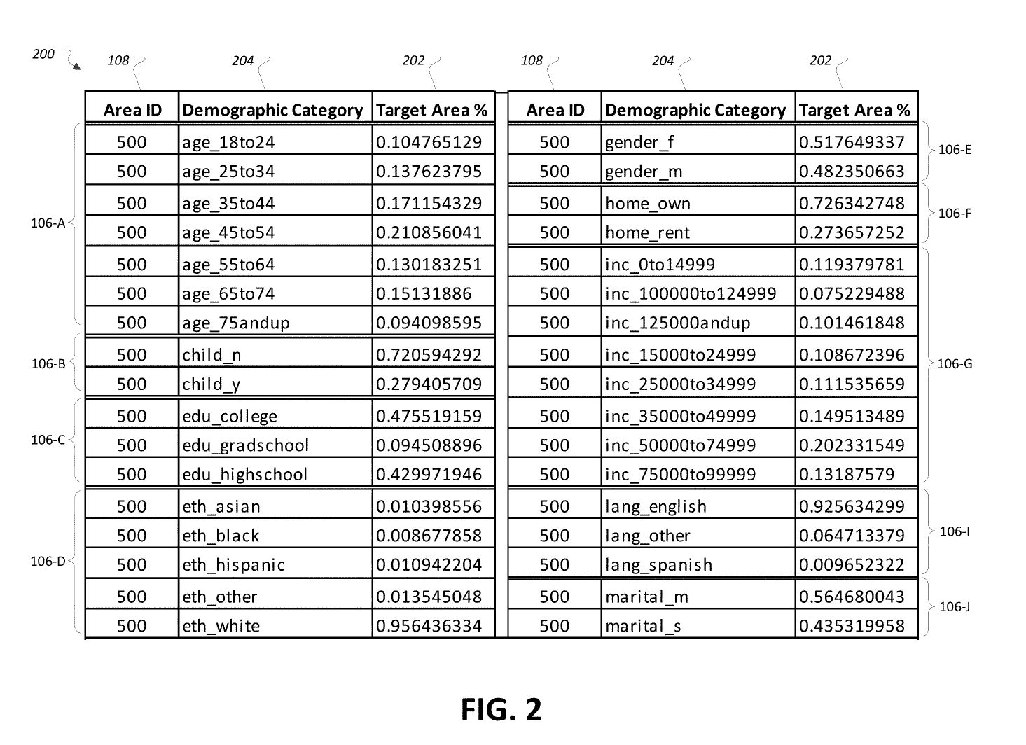

FIG. 2 illustrates an exemplary demographic set 200 of demographic variables 106-A through 106-J (collectively 106) for a population associated with an area identifier 108. As illustrated, the population demographic set 200 includes information regarding the demographic variables 106, for an exemplary area having an area identifier 108 of the value 500. Each of the demographic variables 106 includes a plurality of categories 204. For each of the plurality of categories 204 of the demographic variables 106, the population demographic set 200 further includes a target area breakdown 202 of demographic information 104 regarding those individuals included in the categories 204 and located within the area identifier 108, for example, according to age, parental status, education level, ethnicity, gender, homeowner status, income, primary language, and marital status. In particular, the illustrated target area breakdown 202 includes information regarding the relative amounts of the population that are included in which categories 204 of the demographic variables 106.

For instance, with respect to age, the target area breakdown 202 may include information regarding what percentage of the population is in the demographic categories 204 of 18-24, is 25-34, is 35-44, is 45-54, is 55-64, is 65-74 and is 75 and older. In some cases, there may also be some individuals categorized into an unknown demographic category 204 for whom their age is unknown. Regardless, the sum of each of these percentages of the demographic categories 204 including unknowns (as well as the sum of the percentages of the population for the other breakdowns 202) should equal 100% of the included population.

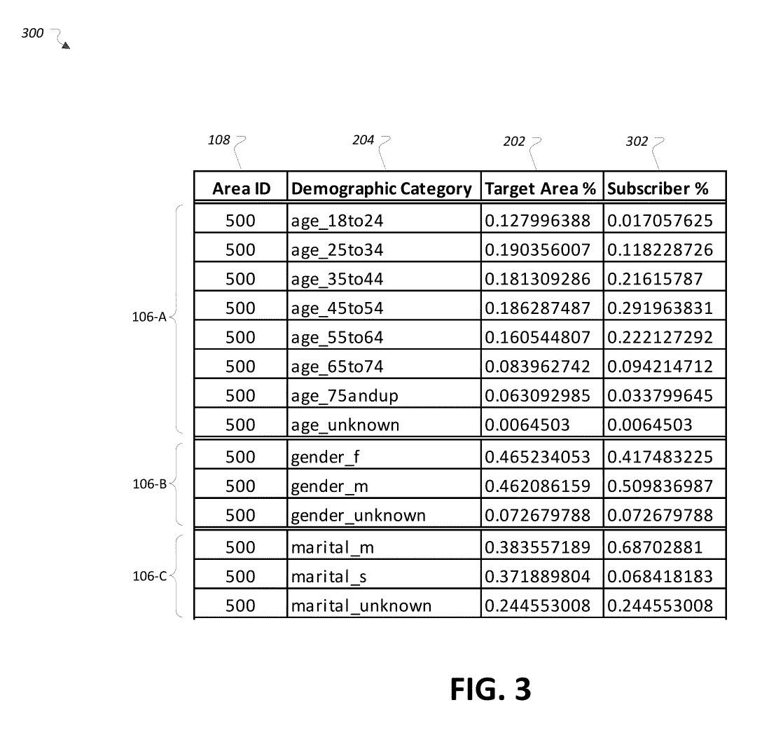

FIG. 3 illustrates an exemplary set 300 of demographic variables 106 for a population associated with an area identifier 108 as compared to a subscriber population. As shown, the demographic set 300 includes a target area breakdown 202 of demographic information 104 regarding those individuals located within the area identifier 108, as well as a subscriber breakdown 302 indicative of the breakdown of the system 100 subscribers located within the same area. For example, the subscriber population includes a greater percentage of population in the categories 204 of 45-74 years old as compared to the target area breakdown 202 (i.e., compared to the population at large), and a lesser percentage of population in the categories 204 included individuals of less than 45 years old. As additional examples, the subscriber population includes a substantially higher percentage of married persons than the population at large, and more males relative to females than the population at large.

FIG. 4 illustrates an exemplary graphical representation of a rim weighting methodology 400. The weighting module 136 may implement the rim weighting methodology 400 to assign rim weights 138 and national weights 140 commensurate with the subscriber's demographics and geographic home location to each subscriber, to correct the subscriber breakdown 302 to be consistent with the target area breakdown 202.

More specifically, the weighting module 136 may perform the rim weighting to adjust a weighting of the attributes of the subscribers to match the demographics of the areas to which the subscribers are assigned. The rim weighting may start with an initial set of weights, sometimes referred to as design weights, and may proportionally adjust and correct for one demographic variable 106 at a time. To use the exemplary demographic set 200 of demographic variables 106 as an example, each iteration of rim weighting would perform nine adjustments, once for each of the nine demographic variables 106-A through 106-J. (For consistency in results, the rim weighting may perform the adjustments of the demographic variables 106 in a consistent ordering for each iteration.) After a sufficient number of iterations, the rim weights 138 may converge on a set of rim weights 138 within a convergence limit (e.g., within a 1% of the target area breakdown 202). In other cases, the rim weights 138 may not converge, however the non-converged rim weights 138 may still be useful if they allow adjustment of the subscriber population to closer to the target area breakdown 202 than the subscriber breakdown 302.

Mathematically, a formula to produce the rim weights (w) for each iteration may be described as follows:

$${w}_{i \vert j , k}^{( 1 )} = \frac{{P}_{DEMO \vert j , k}}{{\sum }_{i} {w}_{( i - 1 ) \vert j , k} / {\sum }_{i} {w}_{( i - 1 ) \vert j}} \cdot {w}_{( i - 1 )} , \\ where \{ \begin{matrix}{P}_{DEMO} = Proportion given by Demog . data \\ l = 1 , … c ( Iteration ) \\ i = 2 , … , r ( Rim Weights ) \\ j = 1 , … , 9 ( Demographics ) \\ k = 1 , … , m ( Category within Demog . field )\end{matrix} \qquad ( 3 )$$

Notably, the Formula (3) utilizes rim weights 138 starting from 2 and continuing through r, where r is the r^{th} rim weight when convergence is met and l=c. This may be done because, to start the rim weighting process, the first rim weights 138 may be initialized to the set of design weights. In mathematical form, the initial step (i.e., adjusting for the first demographic variable 106 in the first iteration of the rim weighting) may be written as:

$${w}_{1 \vert Age , Category}^{( 3 )} = \frac{{P}_{DEMO \vert Age , Ctegory}}{{\sum }_{1} {design\_weight}_{1 \vert Age , Category} / {\sum }_{1} {design\_weight}_{1 \vert Age}} * design\_weight \qquad ( 4 )$$

While not illustrated, the Formula (4) may actually be multiplied by the design weight. Nevertheless, this term may also be omitted in cases where the design weight is initialized to one. Moreover, in cases where the design weights are all one, the weighting module 136 may further perform a check to ensure that the rim weights 138 assigned in the first step are consistent with the targets for the first demographic variable 106, which would be the case as the first step would adjust equal design weights to be in conformance solely with the first demographic variable 106.

As illustrated in Formula (5) as a specific example of computing a rim weight 138, given a subscriber in the subscriber base information 112 who is in the age group 18-24, that subscriber may be assigned a first rim weight 138 as follows:

$${w}_{1 \vert Age , 18 - 24}^{( 3 )} = \frac{{P}_{DEMO \vert Age , 18 - 24}}{{\sum }_{1} {design\_weight}_{1 \vert Age , 18 - 24} / {\sum }_{1} {design\_weight}_{1 \vert Age}} * design\_weight \qquad ( 5 )$$

To assign the weight 138, the Formula (5) takes the proportions of the first demographic variable 106 (i.e., age), and divides it by the proportion of that demographic variable 106 within the subscribers of the subscriber base. Accordingly, subscribers who are associated with demographic variables 106 that are under-represented in the subscriber population may be assigned larger rim weights 138, while subscribers who are associated with demographic variables 106 that are over-represented in the subscriber population may be assigned smaller rim weights 138. The rim weighting process may continue until a convergence criterion is met. Thus, the sum of the r^{th} rim weights 138 Σwᵣ has the following characteristic:

when w^{(l)}ᵢ=w^{(c)}ᵣ then P_{Subscriber|∀j,∀k}=P_{DEMO|∀j,∀k} (6)

To use an exemplary convergence limit criterion of 1%, the Formula (6) may state that the rim weighting continues until all demographic variables 106 of the subscriber breakdown 302 are within the 1% of the target area breakdown 202 percentages. Therefore, convergence is met if:

$$\vert ( \frac{{\sum }_{i = r} {w}_{r \vert j , k}^{( c )}}{{\sum }_{i = r} {w}_{r \vert j}^{( c )}} ) - {P}_{DEMO \vert j , k} \vert < 0.01 , \\ where \\ i , j , k , l -> c , r follow the prior assignments \qquad ( 7 )$$

By way of the rim weighting illustrated above mathematically, the proportions for all categories 204 within all demographic variables 106 may be adjusted to be substantially equivalent to the target area breakdown 202 of demographic information 104. When convergence is met, w^{(c)}ᵣ becomes the rim weight 138 associated with the individual subscriber in the subscriber base information 112.

To make sure the process is running correctly, the weighting module 136 may perform a random check by selecting a table of rim weights 138 that have been generated by the rim weighting, and identify whether the sum of the generated rim weights 138 add up to the correct population area totals. For instance, if the subscriber base information 112 shows 5,000 network subscribers associated with an area identifier 108 (e.g., DMA 500), the rim weights 138 should sum up to 5,000 for those subscribers associated with the area identifier 108 as well. If the computed rim weights 138 are off by a small threshold amount (e.g., less than an arbitrary threshold percentage such as one percent or three percent), the rim weights 138 may be considered by the weighting module 136 to be correct. For instance, if the sum of the rim weighted subscribers is off by less than one subscriber to the total amount of subscribers associated with the area identifier 108 (or as another possibility less than three subscribers off), the weighting module 136 may determine such an offset to be acceptable due to arithmetic rounding error. However if the rim weights 138 are off by greater than the threshold amount, the weighting module 136 may flag that rim weights 138 may not be properly assigned by the weighting module 136.

The weighting module 136 may be further configured to perform a convergence check as a further verification of the rim weights (e.g., see Formula 5 above). For example, the weighting module 136 may be configured to perform a set number of iterations for each DMA (e.g., ten iterations). After the set number of iterations (e.g., nine rim weights 138 corresponding to nine demographic variables 106, for ten iterations=ninety rim weights 138), the weighting module 136 may be configured to verify whether the convergence criterion has been met (e.g., that application of the rim weights 138 to the subscriber base information 112 causes the subscriber base information 112 to conform demographically within a predefined percentage (e.g., 1%) of the target area breakdown 202 for the indicated area.

As a simple example, the iterations of a rim weight 138 for a particular demographic category (e.g., age_{—}45 to 54 within DMA 532) may be reviewed to see whether the successive rim weights 138 are trending toward the demographic proportion for that demographic category and area identifier 108. For instance, if the demographic proportion of 45-54 year olds within the DMA is 0.201575711%, and the rim weights 138 proceed as follows (0.217041292, 0.216035217, 0.215265737, 0.214629648), then the weighting module 136 may determine that the rim weights 138 are converging towards the demographic percentage of 0.201575711%. If however, there is no clear trend in the rim weights 138 from multiple iterations, or if the trend is an oscillation not getting closer to the target demographic percentage, then the weighting module 136 may determine that the rim weights 138 are not converging for that demographic category. For an area to converge, if at least one demographic category in the area does not converge, then the weighting module 136 may indicate that the area has failed convergence; in other words, the weighting module 136 may require all demographic categories associated with an area identifier 108 to converge before considering that area as having converged. Nevertheless, even if an area does not converge, the rim weights 138 may still be useful to apply if the rim weights 138 bring the demographics of the non-converged area closer to the target demographics.

The weighting module 136 may be further configured to create such tables for all categories of each demographic variable 106 in all DMAs. For those DMAs that don't show convergence, more iteration may be used. Once all demographics are confirmed as convergent (or unable to converge), the weighting module 136 may conclude that the subscriber rim weights 138 are computed. As yet a further verification, the weighting module 136 may confirm that the average of all of the subscriber rim weights 138 average to one.

By applying the computed rim weights 138, the weighting module 136 may adjust the subscriber-level data 132 to be in conformance with demographic proportions of the population at large. Moreover, the weighting module 136 may further adjust the subscriber-level data 132 to be on conformance with the size of the population at large (e.g., the zip code, DMA, or nation in which the subscriber is located). To preserve the demographic proportions, the extrapolation may be performed by multiplying the rim weights 138 by a scalar quantity. For instance, if a subscriber population associated with an area identifier 108 may be half the size of the population at large associated with the area identifier 108, the weighting module 136 may multiply the rim weights 138 for subscribers associated with the area identifier 108 by two.

Application of scalar extrapolation may be used to adjust the subscriber population to appear to be the size of the population at large. The more granular demographic information 104 that is available, the more accurate the extrapolation performed by the weighting module 136 may be. As one example, using demographic information 104 at the DMA level, the weighting module 136 may perform the extrapolation at the DMA level. Instead of extrapolating the entire universe of data by the same scalar, each subscriber's scalar may be dependent on in which DMA the subscriber lives. Mathematically, a Formula (9) to produce this scalar (e.g., DMA weight0) may be written as follows:

$$D M A Weight {0}_{d} = \frac{Demographic {Population}_{d}}{Subscriber {Population}_{d}} , \\ where \\ d = D M A code \qquad ( 9 )$$

The weighting module 136 may further multiply the determined DMA weight0 by the subscriber's individual rim weights 138 wᵣ, where r is the rim weight where convergence is met for the demographic variables 106 and categories 204 (i.e., determined as discussed above using rim weighting). The weighting module 136 may accordingly calculate a national weight 140 for each subscriber as follows:

National Weight=(w^{c}ᵣ)(DMA Weight0_{d}) (10)

Once each subscriber is assigned a national weight 140, the weighting module 136 may validate that the national weights 140 sum to the correct amount according to associated area identifier 108. For example, if the demographic information 104 indicates that there are 534,000 individuals living in DMA 500, then Σ National Weight should equal approximately 534,000. If not, then the weighting module 136 may be configured to raise an error flag with respect to the national weight 140 computation.

Thus, by way of the rim weighting methodology 400, each subscriber in the subscriber base information 112 may be assigned a rim weight 138 and a national weight 140. These weights may be used to weight and extrapolate the subscriber-level data 132 to be representative of the population at large.

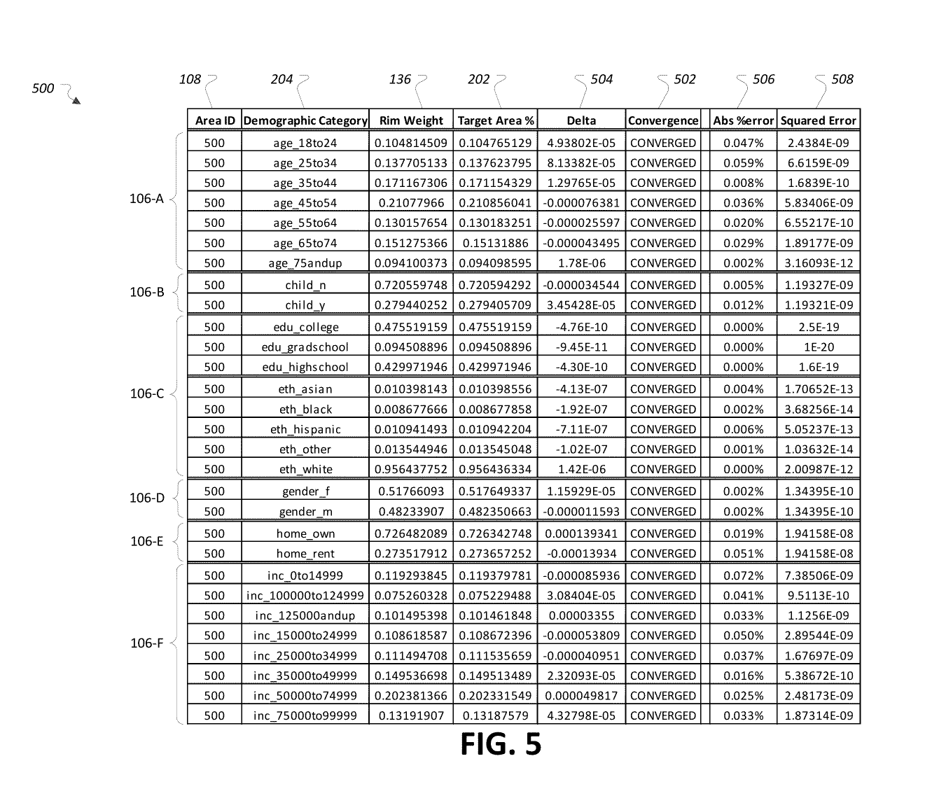

FIG. 5 illustrates an exemplary comparison 500 of determined rim weights 138 to a set of demographic variables 106 for a population associated with an area identifier 108. The comparison 500 includes rim weights 138 determined by the weighting methodology 400 along with the target area breakdown 202 of demographic information 104 regarding those individuals included in the categories 204.

To validate the determined rim weights 138, the weighting module 136 may determine whether a delta 504 between the rim weighted subscriber breakdown 302 and the target area breakdown 202 is within a convergence threshold. For example, the weighing module 136 may determine the delta 504 as a percent of the difference between the rim weighted subscriber breakdown 302 and the target area breakdown 202, and may determine convergence 502 by comparing the delta 504 to a threshold value (e.g., 1%, 5%, etc.). The weighting module 136 may further provide additional aspects regarding the convergence 502. For example, the weighting module 136 may illustrate the delta 504 used to determine convergence 502 by subtracting the rim weights 138 from the target area breakdown 202.

As another example, the weighting module 136 may determine an absolute value of the percentage of the error 506, for example, according to a mean absolute percent error Formula (11):

$$M A P E = \frac{{\sum }_{i = 1}^{n} ( \frac{\vert {rim\_pct}_{i} - {demographic\_pct}_{i} \vert}{{demographic\_pct}_{i}} )}{n} * 100 \qquad ( 11 )$$

As yet a further example, the weighting module 136 may determine a mean least squared error 508 according to a least squares Formula (12) as follows:

$$M S E = \frac{{\sum }_{i = 1}^{n} {( {rim\_pct}_{i} - {demographic\_pct}_{i} )}^{2}}{n - 1} \qquad ( 12 )$$

It is noted that the errors 506 and 508 illustrated in the FIG. 6 are for converged data, and therefore are relatively small. However, in other cases the determined rim weights 138 may not converge. As one example, convergence may be difficult to achieve in an area where there are relatively few subscribers in general, and where out of the subscribers, there are relatively few associated with a particular category 204 as compared to a target area breakdown 202. For instance, in a DMA where a category 204 of those who speak a language other than English are significantly underrepresented (e.g., where there are only approximately 9% of the subscriber base where the population at large includes 43% of such persons), it may be difficult to find convergence of the rim weights 138. In such a case a large delta 504 may occur (e.g., 30%). With deltas 504 this large, applying the rim weights 138 may not actually increase the conformance of the subscriber base, and may in some cases even be counterproductive, making the subscriber base less representative of the population at large. Accordingly, the weighting module 136 may be configured to raise an error flag for areas in which the rim weights 138 fail to converge.

FIG. 6 illustrates an exemplary capping of national weights 140 for a population of subscribers. One downside about a weighting process is that the smaller the initial population, the larger the national weights 140 may be to cause the weighted data to be in conformance with a larger population. In many examples, with a sufficiently sized subscriber base, less than 0.01% of the national weights 140 are greater than 100, and even fewer greater than 1,000. Nevertheless, the weighting may occasionally produce very high national weights 140, such that certain heavily underrepresented subscribers are assigned national weights 140 on the order of tens or hundreds of thousands. As illustrated, the box plot 602-A includes a first quartile 604-A of the lowest 25% of weights, a second quartile 606-A included the next 25% of weights to 50%, a third quartile 608-A including the next 25% of weights to 75%, and a fourth quartile 610-A of weights including the highest weights. When a subscriber having a weight at the high end of the fourth quartile 610-A appears in a report 152 data set, any actions performed by the heavily weighted subscriber may unrealistically alter a resultant reports 152.

It may be difficult to provide a simple cap to the national weights 140, as a simple 99^{th} percentile cap may be too low. Thus, one approach to perform capping and flooring of national weights 140 is to perform a normal distribution on the national weights 140. For example, the weighting module 136 may be configured to transform the national weights 140 using a log transformation. The log transformation may introduce skew into the national weights 140, but the skew may be acceptable due to the removal of the exceedingly high national weights 140. As illustrated, the box plot 602-B includes a normalized first quartile 604-B, second quartile 606-A, third quartile 608-A, and fourth quartile 610-B. Notably, the high national weights 140 assigned to the subscribers have been reduced by the transformation. As one example of this reduction in range of the national weights 140, the highest weight 612-B in the normalized plot 802-B is substantially lower than the highest weight 612-A of the original plot 612-A.

Some exemplary possible Formulas (13) for performing the log transformation of the national weights 140 are as follows:

$$\begin{matrix}1. {Cap}_{{NATL}_{WT}} = {e}^{\{ {μ log}_{{NATL}_{WT}} + 3 \cdot {σ log}_{{NATL}_{WT}} \}} \\ 2. {Cap}_{{NATL}_{WT}} = {e}^{\{ {μ log}_{{NATL}_{WT}} + 4 \cdot {σ log}_{{NATL}_{WT}} \}} & ( 13 ) \\ 3. {Cap}_{{NATL}_{WT}} = {e}^{\{ {Q}_{3} {log}_{{NATL}_{WT}} + 1.5 \cdot ( {Q}_{3} {log}_{{NATL}_{WT}} - {Q}_{1} {log}_{{NATL}_{WT}} \}} \\ 4. {Cap}_{{NATL}_{WT}} = {e}^{\{ {Q}_{3} {log}_{{NATL}_{WT}} + 2 \cdot ( {Q}_{3} {log}_{{NATL}_{WT}} - {Q}_{1} {log}_{{NATL}_{WT}} \}} \\ 5. {Cap}_{{NATL}_{WT}} = {e}^{\{ {Q}_{3} {log}_{{NATL}_{WT}} + 2.5 \cdot ( {Q}_{3} {log}_{{NATL}_{WT}} - {Q}_{1} {log}_{{NATL}_{WT}} \}} \\ 6. {Cap}_{{NATL}_{WT}} = {e}^{\{ {Q}_{3} {log}_{{NATL}_{WT}} + 3 \cdot ( {Q}_{3} {log}_{{NATL}_{WT}} - {Q}_{1} {log}_{{NATL}_{WT}} \}} & \end{matrix}$$

Each of the possible Formulas (13) illustrates a different way that the weighting module 136 may define outlier limits. By using different scalars (e.g., 1.5, 2, 2.5, etc.), the weighting module 136 may adjust the leniency of the capping of the national weights 140. The larger the scalar, the more relaxed the capping of national weights 140. To illustrate some possibilities, the following Formulas (14) include are exemplary maximum national weight 140 values using each of the Formulas (13):

$$1. {Cap}_{{NATL}_{WT}} = {e}^{\{ {μ log}_{{NATL}_{WT}} + 3 \cdot {σ log}_{{NATL}_{WT}} \}} = 86.39 \\ 2. {Cap}_{{NATL}_{WT}} = {e}^{\{ {μ log}_{{NATL}_{WT}} + 4 \cdot {σ log}_{{NATL}_{WT}} \}} = 304.99 \\ 3. {Cap}_{{NATL}_{WT}} = {e}^{\{ {Q}_{3} {log}_{{NATL}_{WT}} + 1.5 \cdot ( {Q}_{3} {log}_{{NATL}_{WT}} - {Q}_{1} {log}_{{NATL}_{WT}} \}} = 50.11 \\ 4. {Cap}_{{NATL}_{WT}} = {e}^{\{ {Q}_{3} {log}_{{NATL}_{WT}} + 2 \cdot ( {Q}_{3} {log}_{{NATL}_{WT}} - {Q}_{1} {log}_{{NATL}_{WT}} \}} = 115.65 \\ 5. {Cap}_{{NATL}_{WT}} = {e}^{\{ {Q}_{3} {log}_{{NATL}_{WT}} + 2.5 \cdot ( {Q}_{3} {log}_{{NATL}_{WT}} - {Q}_{1} {log}_{{NATL}_{WT}} \}} = 266.91 \\ 6. {Cap}_{{NATL}_{WT}} = {e}^{\{ {Q}_{3} {log}_{{NATL}_{WT}} + 3 \cdot ( {Q}_{3} {log}_{{NATL}_{WT}} - {Q}_{1} {log}_{{NATL}_{WT}} \}} = 615.98 \qquad ( 14 )$$

Because the log transformation is relatively normally distributed, the first or second of the Formulas (13) may be relatively suitable for use. To avoid overly distorting the distribution, a conservative approach may utilize an approach limiting to four standard deviations from the transformed mean. In the above example of the Formulas (14), this may give a maximum capped value of 304.99. Theoretically, four standard deviations to the right of the mean with a random variable X˜N (μ, σ²) may cover more than 99.9% of the likely national weights 140.

For example, if Z is a standard normal, then:

P(Z<4σ)=P(Z<4)=φ(4)=0.99997 (15)

Thus, once the transformation is performed, four standard deviations covers approximately 99.8% of the national weights 140, leaving only approximately 0.19% of the weights affected by the capping value.

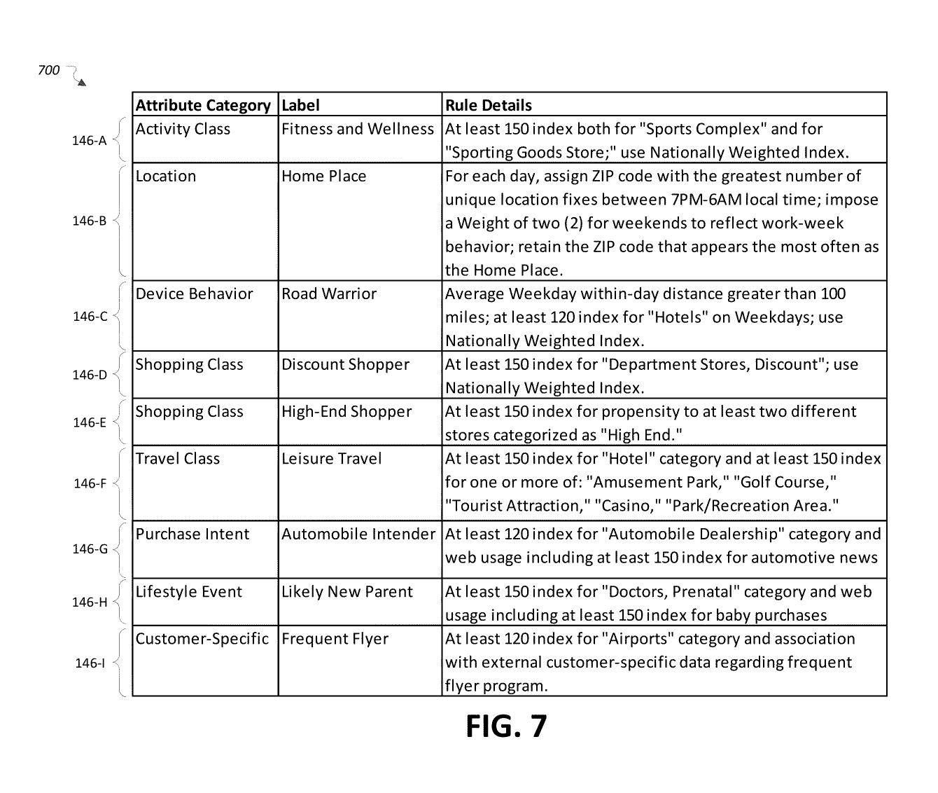

FIG. 7 illustrates an exemplary listing 700 of business rules 146-A through 146-I (collectively 146) to be used in the association of advanced attributes 144 with subscribers. The business rules 146 may include criteria and other logic used to describe the characteristics of subscriber for whom the various advanced attributes 144 of the system are to be assigned. The attribute assignment module 142 of the data warehouse 126 may utilize the business rules 146 in the assignment of advanced attributes 144 to the subscriber level data 132. For example, the attribute assignment module 142 may implement the criteria of the business rules 146 to associate those subscribers matching the business rule 146 criteria with the labels specified in the associated advanced attributes 144. To improve the accuracy of the attribute assignment, the attribute assignment module 142 may be configured to perform the assignment making use of the rim weights 138 and national weights 140, as calculated by the weighting module 136, on the subscriber data.

As an example, the business rule 146-A may indicate criteria for a “Fitness and Wellness” advanced attribute 144 within an “activity” class of a subscriber. The criteria of the business rule 146-A may specify characteristics of subscribers to be associated with the “Fitness and Wellness” advanced attribute 144. For instance, the “Fitness and Wellness” criteria may include that the subscriber has at least a 150 index (i.e., the subscriber is 1.5 times more likely than average) to have visited points of interest within the “Sports Complex” and “Shorting Goods Store” categories as compared to the population at large. In addition to or as an alternative to the “Fitness and Wellness,” other exemplary “activity” advanced attributes 144 may include that a subscriber has a preference for “sports and entertainment,” or that the subscriber is an “outdoor enthusiast.”

To determine the index, the attribute assignment module 142 may analyze the location attributes 120 or subscriber attributes 124 associated with the subscribers over a period of time (e.g., over a continuously rolling data set of the last twenty-eight days or other period of time) to determine index scores. For instance, the attribute assignment module 142 may determine a total count of subscribers that are associated with a particular advanced attribute 144. The attribute assignment module 142 may determine, out of those counted subscribers, an average (e.g., median) number of visits to locations associated with the particular advanced attribute 144, and may further determine an index value for each subscriber by dividing the subscriber's number of visits by the average number of visits to such locations (and optionally multiplying by 100 to aid in readability). For example, out of those subscribers with one or more visits to a “Fitness and Wellness” location, the attribute assignment module 142 may identify that the average number of visits to such locations is twenty. Thus, a subscriber with twenty location fixes at “Fitness and Wellness” would be assigned an index score of 100, while a subscriber with twenty-five visits would be assigned an index score of 125. In some cases, the index may be national and may be determined using the national weights 140. In other cases, the index may be more local and may be determined using the rim weights 138 as another possibility.

As another example, the business rule 146-B may indicate the criteria for a location-based attribute indicative of a “Home Place” for a subscriber. The advanced attribute 144 may take the form of a postal code, DMA, or other location identifier indicative of the location in which the subscriber may be considered to be home. For instance, a subscriber may be associated with a “Home Place” postal code according to criteria including the subscriber being within that postal code the most during the hours of 7 PM to 6 AM local time. The criteria may further specify an additional weighting for weekend days over week-days, to reflect workweek behavior and the increased likelihood for the subscriber to be near a home location on weekends.

As another possibility, the business rule 146-C may indicate the criteria for an advanced attribute 144 indicative of a “Device Behavior” class of a subscriber, where the “Device Behavior” class includes advanced attributes 114 specifying a movement classification for the subscriber as compared to the population at large. For instance, a subscriber may be associated with one or more of a “Road Warrior,” “Local Commuter,” “Home Body,” or “Super Commuter” advanced attribute 144, according to the pattern of visited locations in the location attributes 120 of the subscriber-level data 132. A “Road Warrior,” for example, may be defined as a subscriber having an average within-day Mon-Fri distance more than 100 miles and having an index score of at least 120 for visiting points of interest in a “Hotel” category on weekdays.

As yet another example, the business rules 146-D and 146-E may each indicate criteria for advanced attributes 144 indicative of a “Shopping” class of a subscriber. For instance, a subscriber who has an index of at least 150 for discount department stores may be associated with a “Discount Shopper” advanced attribute 144. Or, a subscriber who has an index of at least 150 for at least two different high end stores (e.g., “Coach,” “Nordstrom,” etc.) may be assigned a “High End Shopper” advanced attribute 144.

As yet another possibility, the business rule 146-F may indicate the criteria for an advanced attribute 144 indicative of a “Travel” class of a subscriber (e.g., “Leisure Traveler,” “Business Traveler,” etc.). For instance, a subscriber may be associated with a “Leisure Travel” advanced attribute 144 if the subscriber has at least a 150 index for “Hotel” points of interest and also at least a 150 index for one or more of “Amusement Parks,” “Golf Courses,” “Tourist Attractions,” “Casinos” or “Park/Recreation Areas.”

The business rules 146 may further take into consideration subscriber attributes 124 based on the web and application usage data 122. For example, the business rule 146-G may indicate criteria for an advanced attribute 144 indicative of a “Purchase Intent” of a subscriber. As a specific example, an “Automotive Intender” advanced attribute 144 may include criteria such as having an index of at least 120 for “Automobile Dealership” category of point of interest locations, and also subscriber attributes 124 indicative of web usage including at least an index of 150 for automotive news websites. A subscriber associated with the “Automotive Intender” advanced attribute 144 may accordingly be more likely to purchase an automobile in the near future than the population at large. As another example, the business rule 146-H may indicate criteria for an advanced attribute 144 indicative of a “Lifestyle Event” of a subscriber. As a specific example, a “Likely New Parent” advanced attribute 144 may include criteria such as having an index of at least 150 for a “Prenatal Doctors” category of point of interest locations, and also subscriber attributes 124 indicative of web usage including at least an index of 150 for baby-related purchases.

In some cases, the business rules 146 may also take into account third-party data collected outside of the system 100. As an example, the business rule 146-I may indicate criteria for an advanced attribute 144 indicative of a “Customer-Specific” classification of a subscriber. For instance, a “Frequent Flier” advanced attribute 144 may include criteria such as the subscriber having at least an index of 120 for an “Airports” point of interest category and also association with external customer-specific data regarding a frequent flyer program (e.g., frequent flier mileage exceeding a threshold amount of times, an airline-specific frequent flier level, etc.).

These and other business rules 146 may be specified into the system 100, and used to generate indications of complicated subscriber behaviors or histories that may be otherwise difficult to proportionally measure compared to the population at large or identify as potential advertising targets.

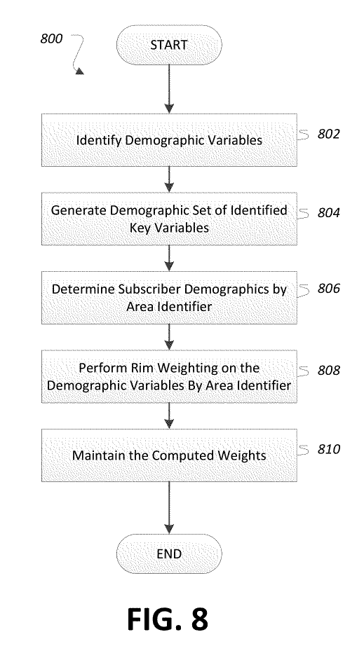

FIG. 8 illustrates an exemplary process 800 for the generation of rim weights 138 and national weights 140 for subscribers to use in report generation. The process 800 may be performed for example, by a data warehouse 126 executing a weighting module 136 and in communication with a demographic data source 102, an account data source 110 and a subscriber network 114.

At block 802, the data warehouse 126 identifies key demographic variables 106 to use to transform a population of subscribed described by subscriber base information 112 to be commensurate with the demographics and population size of a population described by demographic information 104. As one example, the weighting module 136 may identify the key set of demographic variables 106 for which the subscriber base information 112 may be weighted to include: age, gender, income, education, marital status, presence of children in the household, primary language, race, and whether the subscriber is a homeowner. The weighting module 136 may further determine an ordering of the demographic variables 106 to use in the transformation.

At block 804, the data warehouse 126 generates a demographic set 200 of the identified demographic variables 106 for populations associated with area identifiers 108 in which rim weights 138 are to generated. For example, the data warehouse 126 may receive demographic information 104 from a demographic data source 102, and based on the data may create proportions of the included population of each demographic category 204 of the identified demographic variables 106 and area identifiers 108. For instance, the data warehouse 126 may divide a total of individuals associated with the demographic category 204 and area identifier 108 with a total of the individuals associated with the area identifiers 108. An exemplary set 200 of demographic variable 106 for a population associated with an area identifier 108 is illustrated in FIG. 2.

At block 806, the data warehouse 126 determines subscriber demographics by area identifier 108. For example, the data warehouse 126 may receive subscriber base information 112 from the account data source 110, and for each area identifier 108, may identify those subscribers who are located in the area identifier 108 according to address information included in the subscriber base information 112. The data warehouse 126 may further identify demographic categories 204 of the demographic variables 106 associated with each of the subscribers according to the subscriber base information 112. For instance, the data warehouse 126 may determine an age range demographic category 204 of an age demographic variable 106 according to birth date information included in the subscriber base information 112. As another example, the data warehouse 126 may correlate subscriber in the subscriber base information 112 with demographic information 104 indicative of demographics regarding residents (e.g., census information, third-party compiled information from a vendor such as Experian™ or Acxiom™), or other information regarding subscribers based on their attributes (e.g., age, gender, race, income, primary language), in many cases broken down geographically (e.g., by state, DMA, or zip code). An exemplary set 300 of demographic variable 106 for a population associated with an area identifier 108 including a subscriber breakdown 302 is illustrated in FIG. 3.

At block 808, the data warehouse 126 performs rim weighting on the subscriber breakdowns 302 for each area identifier 108 according to the respective target area breakdowns 202 for each area identifier 108. For example, the data warehouse 126 may utilize a rim weighting module 136 to determine rim weights 138 and national weights 140 associated with each subscriber. The rim weights 138 may reflect the amount of contribution that each subscriber should have to data regarding the area identifier 108 in which the subscriber is based, while the national weights 140 may reflect the amount of contribution that each subscriber should have to data regarding a national area in which the subscriber is based that encompasses multiple are identifiers 108. Further aspects of the determination of the rim weights 138 and national weights 140 are discussed below with respect to the process 900.

At block 810, the data warehouse 126 maintains the determined rim weights 138 and national weights 140 for use in generation of reports 152, e.g., by a report generator module 150 of a reporting device 148. Further aspects of the generation of reports 152 are discussed below with respect to the process 1100. After block 810, the process 800 ends.

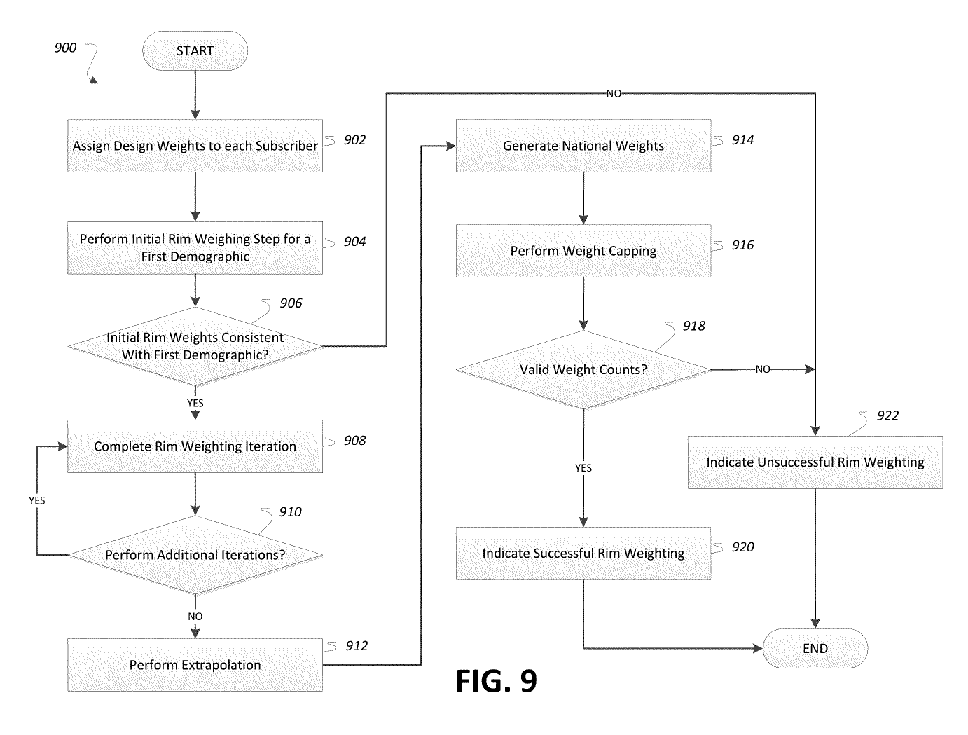

FIG. 9 illustrates an exemplary process 900 for performing rim weighting, extrapolation, and weight capping. As with the process 800, the process 900 may be performed for example, by a data warehouse 126 executing a weighting module 136 and in communication with a demographic data source 102, an account data source 110 and a subscriber network 114.

At block 902, the data warehouse 126 assigns design weights to each subscriber for which a rim weight 138 is to be generated. For example, to start the rim weighting process, the weighting module 136 may initialize a set of first rim weights 138 to a set of design weights. As one possibility, each initial design weight may be assigned the value of one.

At block 904, the data warehouse 126 performs an initial rim weighing for a first identified demographic variable 106. For example, as discussed above with respect to Formulas (4) and (5), the weighting module 136 may perform an initial step adjusting the design weights for the first demographic variable 106 in the first iteration of the rim weighting to generate a first set of rim weights 138. This first set of rim weights 138 are adjusted to be in conformance with a target area breakdown 202 indicative of a breakdown of demographic categories 204 of individuals with respect to the first demographic variable 106.

At decision point 906, the data warehouse 126 validates the first set of rim weights 138 of the first demographic variable 106. For example, the weighting module 136 may perform a check to ensure that the rim weights 138 assigned in the first step are consistent with the target area breakdowns 202 for the first demographic variable 106 (e.g., age), which would be the case as the first step would adjust equal design weights to be in conformance solely with the first demographic variable 106. If the first set of rim weights 138 of the first demographic variable 106 is consistent with the target area breakdowns 202 for the first demographic variable 106, control passes to block 908. Otherwise control passes to block 922.

At block 908, the data warehouse 126 completes the rim weighting iteration. For example, as discussed above with respect to Formula (5), the weighting module 136 may perform steps further adjusting the rim weights 138 for each of the demographic variables 106, based on the target area breakdowns 202 for each of the demographic variables 106. In one illustrative approach the weighting module 136 may adjust the rim weights 138 for a second of the demographic variables 106 (e.g., gender), although the other demographic variables 106 (e.g., age, income, etc.) may become inaccurate proportionally to the adjustments made for the second demographic variable 106. As another example, the weighting module 136 may further adjust the rim weights 138 for a third of the demographic variables 106 (e.g., income), although the other demographic variables 106 (e.g., age, gender, etc.) may become off proportionally to the adjustments made for the third demographic variable 106. In some cases, the weighting module 136 may perform the rim weighting iteration according to a determined ordering of the demographic variables 106 (e.g., as determined in block 802 above) to provide for more consistent results.

At decision point 910, the data warehouse 126 determines whether to perform additional iterations of rim weighting. For example, as discussed above with respect to Formulas (6) and (7), the weighting module 136 may continue the weighting process until a convergence criterion is met. To use an exemplary convergence limit criterion of 1%, the Formula (6) may state that the rim weighting continues until each demographic category 204 of each demographic variable 106 of the subscriber breakdown 302 is within the 1% of the target area breakdown 202 percentages. Additionally or alternately, the weighting module 136 may continue the rim weighting until execution of a predefined number of iterations of rim weighting (e.g., ten iterations, one hundred iterations, etc.). If the weighting module 136 determines to perform additional rim weighting iterations, control passes to block 908. Otherwise, control passes to block 912.

At block 912, the data warehouse 126 performs extrapolation on the generated rim weights 138. For example, as discussed above with respect to Formula (9) the weighting module 136 may be configured to apply a scalar extrapolation to adjust the rim weighted subscriber population to appear to be the size of the population at large. Notably, the scalar extrapolation may generally be greater in magnitude the smaller the size of the subscriber population is compared to the size of the population at large.

At block 914, the data warehouse 126 generates national weights 140. For example, as discussed above with respect to Formula (10), the weighting module 136 may be configured to generate national weights 140 based on rolling up the extrapolated generated rim weights 138 for individual areas to geographic areas including multiple area indications 108.

At block 916, the data warehouse 126 performs weight capping. For example, as discussed above with respect to Formulas (13) and (14), the weighting module 136 may be configured to transform the national weights 140 using a log transformation. As one possibility, the log transformation may be configured to limit the national weights 140 to four standard deviations to the right of the mean, which may cover more than 99.9% of the likely national weights 140.

At block 918, the data warehouse 126 validates the generated rim weights 138. For example, to ensure that the rim weighting is running correctly, the weighting module 136 may select determined rim weights 138 for one or more area indications 108 for validation. In some examples, this selection may be performed randomly, while in other cases all or substantially all of the determined rim weights 138 may be validated by the weighting module 136. To perform the validation, the weighting module 136 may determine whether a sum of the rim weights 138 add up to a correct total of subscribers indicated by the subscriber base information 112 as included within the area indications 108. For instance, if the demographic information 104 indicates that there are 5,000 individuals in a particular DMA, then the rim weighted subscriber counts for that area should sum up to substantially 5,000 subscribers as well. In some cases, due to rounding the rim weights 138 may be off by on the order of one subscriber, which the weighting module 136 may still be configured to consider as valid. However, in cases where the rim weighted subscriber counts differ substantially from the actual number of individuals, then the weighting module 136 may indicate that the rim weights 138 are incorrect. As yet a further verification, the weighting module 136 may confirm that all of the subscriber rim weights 138 average to one. If the weighting module 136 determines the rim weights 138 to be valid, control passes to block 920. Otherwise, control passes to block 922.

At block 920, the data warehouse 126 indicates that the rim weights 138 and national weights 140 are generated successfully. For example, the rim weights 138 and national weights 140 may be provided to the data store 128 to be maintained and used to weight and extrapolate subscriber data (e.g., network usage data 118, web and application usage data, etc.) to be representative in proportion and size to the population at large. In some cases, a message may be provided to a system administrator or placed in a log file that the rim weights 138 and national weights 140 are generated successfully. After block 920, the process 900 ends.

At block 922, the data warehouse 126 indicates that the rim weights 138 and national weights 140 are not generated successfully. For example, the rim weights 138 and national weights 140 may not be provided to the data store 128 and previous rim weights 138 and national weights 140 may be used. As another possibility, a message may be provided to a system administrator or placed in a log file that the rim weights 138 and national weights 140 are not generated successfully. After block 922, the process 900 ends.

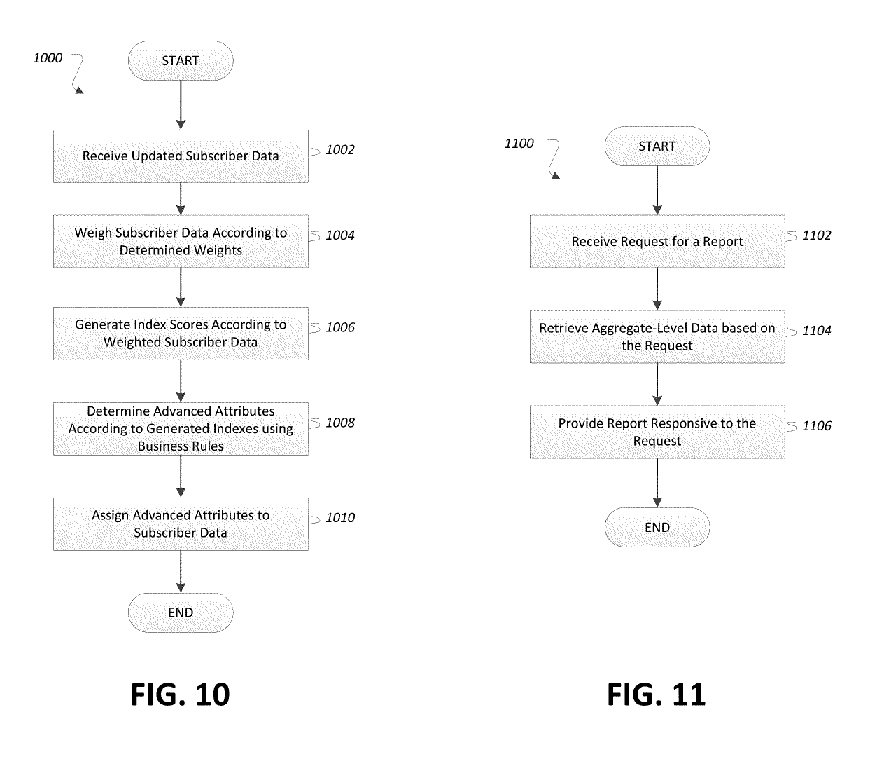

FIG. 10 illustrates an exemplary process for the assignment of advanced attributes to subscribers. The process 1000 may be performed for example, by a data warehouse 126 executing an attribute assignment module 142 and in communication with a data store 128 including subscriber level data 132, rim weights 138 and national weights 140.

At block 1002, the data warehouse 126 receives updated subscriber data. The subscriber data may include, for example, network usage data 118 including location attributes 120 and web and application usage data including subscriber attributes 124. In some examples, the data warehouse 126 may receive periodic daily aggregated updates of network usage data 118 and web and application usage data 122 from the subscriber network 114.

At block 1004, the data warehouse 126 weights the subscriber data to reflect the amount of contribution that each subscriber should have to data regarding the area in which the subscriber is based. For example, the attribute assignment module 142 may be configured to weigh the subscriber data associated with each subscriber in accordance with the respective subscriber rim weights 138 or national weights 140 calculated by the weighting module 136 as discussed above in the process 900.

At block 1006, the data warehouse 126 generates index scores according to weighted subscriber data. For example, the attribute assignment module 142 may determine a total count of subscribers that are associated with a particular advanced attribute 144 as well as an average number of visits to locations associated with the advanced attribute 144 for such visiting subscribers. The attribute assignment module 142 may further determine an index value for each subscriber by dividing the subscriber's number of visits by the computed average number of visits.

At block 1008, the data warehouse 126 utilizes business rules 146 to determine advanced attributes 144 to assign to the subscribers. For example, the attribute assignment module 142 may implement the criteria of the business rules 146 to associate those subscribers matching the criteria with the labels specified in the associated advanced attributes 144.

At block 1010, the data warehouse assigns the advanced attributes 144 to the subscribers. For example, the advanced attribute 144 subscriber associations may be maintained in the data store 128 of the data warehouse 126 and used for the generation of reports 152. After block 1010, the process 1000 ends.

FIG. 11 illustrates an exemplary process 1100 for the generation of reports 152 from aggregate subscriber data 134. The process 1100 may be performed, for example, by a reporting device 148 of the system 100 in communication with a data warehouse 126 and one or more requesting devices.

At block 1102, the reporting device 148 receives a request for a report 152 from a requesting device. The request may include criteria for the report 152, such as one or more advanced attributes 144.

At block 1104, the reporting device 148 retrieves aggregate subscriber data 134 based on the received request. For example, the reporting device 148 may query the aggregate subscriber data 134 for subscriber profiles matching the advanced attributes 144 included in the request.

At block 1106, the reporting device 148 provides the report 152 to the requesting device, responsive to the request. After block 1106, the process 1100 ends.

Thus, system 100 may utilize rim weighting to generate the rim weights 138 and national weights 140 that apply greater weight to data from subscribers who are demographically under-represented, and lower weights to those who are demographically over-represented. The weighted subscriber data may be used to facilitate accurate generation and reporting of relative quantities of advanced attributes 144 relative to the population at large.

For example, the system 100 may further support the providing of reports 152 using a reporting device 148, to allow marketers and other users to query the aggregate subscriber data 134 according to advanced attributes 144, thereby allowing the users to identify aspects of the behavior of the subscribers that may be useful for making marketing decisions. As one possibility, rather than merely providing reports 152 regarding a subscriber with an attribute based on proximity to a retailer a predetermined number of times within a time period (e.g., five visits to a discount retailer), a marketer or business owner may configure the reporting device 148 to provide periodic reports 152 according to advanced attributes 144 of the subscriber compared to the exposure of the population at large (e.g., 1.5 times more likely to visit a discount retailer than average). As another possibility, the marketer or business may configure the system 100 to provide a report 152 to allow the marketer or business to observe an effect of an advertising campaign as targeting various categories of consumer. For instance, the report 152 may be indicative of an increased population of consumers associated with certain advanced attributes 144 (e.g., a large number of “outdoor enthusiasts”) as compared to others groups, providing insight into the effectiveness of the advertising campaign in reaching consumers associated with different advanced attributes 144.

Moreover, the reporting device 148 may further be configured to provide notifications regarding suggested courses of action based on the report 152 data. For example, the reporting device 148 may determine, based on the report 152 data, that a business should be notified to consider adjusting staffing hours to accommodate an increased or decreased population of consumers associated with certain advanced attributes 144 (e.g., days or hours that require additional staffing to accommodate the unique needs of the particular category of consumers or days or hours for which staffing may be reduced). As another possibility, based on an identification of unexpectedly large or small populations of consumers associated with certain advanced attributes 144 at certain locations, the reporting device 148 may determine to notify the business to adjust an amounts of merchandise to have on hand at various locations to handle expected customer demand (e.g., if a large number of “outdoor enthusiasts” are expected, then the reporting device 148 may notify the business to increase inventory levels of outdoor items such as tents or backpacks).

These notifications, including the suggested courses of action based on the report 152 data, may be provided from the reporting device 148 to businesses and marketers in various ways. For instance, the notifications of suggested courses of action may be provided to a set of one or more subscriber identifiers 116 associated with the business by text message (e.g., via short message service (SMS), instant message, etc.). As another possibility, these notifications may be provided to the business as calendar entries automatically added for those days where a course of action is suggested by the reporting device 148 (e.g., a day for which inventory levels or staffing levels may require adjustment based on the reports 152). As yet a further possibility, these notifications may be provided as e-mail messages to a set of one or more e-mail addresses of the business configured with the reporting device 148 to receive the notifications. Still further, the notifications may be provided to a notification application executed by a subscriber device connected to the subscriber network 114, where a subscriber identifier 116 of the subscriber device is configured with the reporting device 148 to receive the notifications.

In general, computing systems and/or devices, such as the demographic data source 102, account data source 110, data warehouse 126 and reporting device 148, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing devices, such as the demographic data source 102, account data source 110, data warehouse 126 and reporting device 148, generally include computer-executable instructions such as the instructions of the data integration module 130, weighting module 136, attribute assignment module 142 and report generator module 150, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Objective C, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein, such as the demographic data source 102, account data source 110 and data store 128 of the data warehouse 126, may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A computing device configured to execute a software application on a processor of the computing device to provide operations comprising:
generating target area breakdowns of demographic information for a plurality of geographic areas based on identified demographic variables of subscribers of a subscriber network received from a demographic data source device;
determining subscriber demographic breakdowns for each of the target area breakdowns based at least in part on subscriber base information received from an account data source device and descriptive of subscribers of the subscriber network;
performing rim weighting of the subscriber demographic breakdowns to generate rim weights for each subscriber according to the respective target area breakdowns; and
maintaining the determined rim weights in a data store to be used to weigh subscriber data generated from data records of the subscriber network representing usage of the subscriber network by subscriber devices.

2. The computing device of claim 1, further configured to perform operations comprising extrapolating the relative weights to adjust a size of the subscriber base information to match a demographic size of the geographic areas to which the subscribers are assigned.

3. The computing device of claim 1, further configured to perform operations comprising:
generating national weights for the subscribers based on the rim weights; and
performing a normal distribution on the national weights for at least one of capping and flooring the national weights.

4. The computing device of claim 3, further configured to perform operations comprising:
receiving subscriber data including at least one of network usage data, and web and application usage data;
weighting the subscriber data according to at least one of the rim weights and the national weights;
generating index scores according to weighted subscriber information, each index score indicative of relative likelihood of a subscriber being associated with an attribute as compared to a population of the associated geographic area.

5. The computing device of claim 4, further configured to perform operations comprising:
identifying a business rule including criteria for association of a subscriber with an advanced attribute, the criteria including a minimum index score for the advanced attribute; and
assigning the advanced attribute to the subscriber based on the index score of the subscriber exceeding the minimum index score specified by the business rule.

6. The computing device of claim 5, further configured to perform operations comprising:
receiving a request for a report, the request specifying subscribers associated with the advanced attribute;
retrieving aggregate subscriber data based on the request; and
providing a report responsive to the request including data on subscribers associated with the advanced attribute.

7. The computing device of claim 1, further configured to perform validation operations comprising at least one of:
(i) performing an initial weighting step for a first of the identified key demographic variables, and verifying that initial rim weights are consistent with the target area breakdowns for the first demographic variable;
(ii) verifying that a sum of the rim weighted subscriber base information for a geographic area equals a total of subscribers indicated by the demographic information as included within the geographic area; and
(iii) verifying that an average of all of the subscriber rim weights averages to one.

8. A method, comprising:
generating target area breakdowns of demographic information for a plurality of geographic areas based on identified demographic variables of subscribers of a subscriber network received from a demographic data source device;
determining subscriber demographic breakdowns for each of the target area breakdowns based at least in part on subscriber base information received from an account data source device and descriptive of subscribers of the subscriber network;
performing rim weighting of the subscriber demographic breakdowns to generate rim weights for each subscriber according to the respective target area breakdowns; and
maintaining the determined rim weights in a data store to be used to weigh subscriber data generated from data records of the subscriber network representing usage of the subscriber network by subscriber devices.

9. The method of claim 8, further comprising extrapolating the relative weights to adjust a size of the subscriber base information to match a demographic size of the geographic areas to which the subscribers are assigned.

10. The method of claim 8, further comprising:
generating national weights for the subscribers based on the rim weights; and
performing a normal distribution on the national weights to at least one of cap and floor the national weights.

11. The method of claim 10, further comprising:
receiving subscriber data including at least one of network usage data and web and application usage data;
weighting the subscriber data according to at least one of the rim weights and the national weights; and
generating index scores according to weighted subscriber information, each index score indicative of relative likelihood of a subscriber being associated with an attribute as compared to a population of the associated geographic area.

12. The method of claim 11, further comprising:
identifying a business rule including criteria for association of a subscriber with an advanced attribute, the criteria including a minimum index score for the advanced attribute; and
assigning the advanced attribute to the subscriber based on the index score of the subscriber exceeding the minimum index score specified by the business rule.

13. The method of claim 12, further comprising:
receiving a request for a report, the request specifying subscribers associated with the advanced attribute;
retrieving aggregate subscriber data based on the request; and
providing a report responsive to the request including data on subscribers associated with the advanced attribute.

14. The method of claim 8, further comprising:
(i) performing an initial weighting step for a first of the identified key demographic variables, and verifying that initial rim weights are consistent with the target area breakdowns for the first demographic variable;
(ii) verifying that a sum of the rim weighted subscriber base information for a geographic area equals a total of subscribers indicated by the demographic information as included within the geographic area; and
(iii) verifying that an average of all of the subscriber rim weights averages to one.

15. A non-transitory computer-readable medium tangibly embodying computer-executable instructions of a software program, the software program being executable by a processor of a computing device to provide operations comprising:
generating target area breakdowns of demographic information for a plurality of geographic areas based on identified demographic variables of subscribers of a subscriber network received from a demographic data source device;
determining subscriber demographic breakdowns for each of the target area breakdowns based at least in part on subscriber base information received from an account data source device and descriptive of subscribers of the subscriber network;
performing rim weighting of the subscriber demographic breakdowns to generate rim weights for each subscriber according to the respective target area breakdowns; and
maintaining the determined rim weights in a data store to be used to weigh subscriber data generated from data records of the subscriber network representing usage of the subscriber network by subscriber devices.

16. The computer-readable medium of claim 15, further executable by a processor of a computing device to provide operations comprising extrapolating the relative weights to adjust a size of the subscriber base information to match a demographic size of the geographic areas to which the subscribers are assigned.

17. The computer-readable medium of claim 15, further executable by a processor of a computing device to provide operations comprising:
generating national weights for the subscribers based on the rim weights; and
performing a normal distribution on the national weights to at least one of cap and floor the national weights.

18. The computer-readable medium of claim 15, further executable by a processor of a computing device to provide operations comprising:
receiving subscriber data including at least one of network usage data and web and application usage data;
weighting the subscriber data according to at least one of the rim weights and the national weights;
generating index scores according to weighted subscriber information, each index score indicative of relative likelihood of a subscriber being associated with an attribute as compared to a population of the associated geographic area.

19. The computer-readable medium of claim 18, further executable by a processor of a computing device to provide operations comprising:
identifying a business rule including criteria for association of a subscriber with an advanced attribute, the criteria including a minimum index score for the advanced attribute; and
assigning the advanced attribute to the subscriber based on the index score of the subscriber exceeding the minimum index score specified by the business rule.

20. The computer-readable medium of claim 19, further executable by a processor of a computing device to provide operations comprising:
receiving a request for a report, the request specifying subscribers associated with the advanced attribute;
retrieving aggregate subscriber data based on the request; and
providing a report responsive to the request including data on subscribers associated with the advanced attribute.

21. The computer-readable medium of claim 15, further executable by a processor of a computing device to provide operations comprising:
(i) performing an initial weighting step for a first of the identified key demographic variables, and verifying that initial rim weights are consistent with the target area breakdowns for the first demographic variable;
(ii) verifying that a sum of the rim weighted subscriber base information for a geographic area equals a total of subscribers indicated by the demographic information as included within the geographic area; and
(iii) verifying that an average of all of the subscriber rim weights averages to one.
